(19) United States
(12) Patent Application Publication
(10) Pub. No.: US 2015/0264969 A1
(43) Pub. Date: Sep. 24, 2015

(54) Nutritional Beverage Product

(71) Applicant: Fortis Beverages, LLC, Hollidaysburg, PA (US)

(72) Inventor: Frederick T. Murphy, Hollidaysburg, PA (US)

(21) Appl. No.: 14/661,877

(22) Filed: Mar. 18, 2015

Related U.S. Application Data
(60) Provisional application No. 61/954,794, filed on Mar. 18, 2014.

(51) Int. Cl. A23L 2/52; A23L 2/385; A23L 2/58

(52) U.S. Cl. CPC A23L 2/52; A23L 2/58; A23L 2/385; A23V 2002/00

(57) ABSTRACT

A beverage product, and composition therefore, for providing relief from hangover symptoms by replenishment or preventative hydration and supplementation of nutrients lost as a result of alcohol consumption comprising a composition causing the beverage to be hypo-osmolar and comprise a low glycemic index. Also, a method of relieving hangover symptoms by replenishment or preventative hydration and supplementation of nutrients lost as a result of alcohol consumption comprising providing to a mammal a beverage including a composition causing the beverage to be hypo-osmolar and comprise a low glycemic index.

### CROSS REFERENCE TO RELATED APPLICATIONS

This application claims benefit of priority from U.S. Provisional Patent Application No. 61/954,794, filed Mar. 18, 2014, which is incorporated herein by reference in its entirety.

### FIELD OF THE INVENTION

The present invention is related to a nutritional beverage product and related methods, and in particular a functional beverage product to facilitate hydration while providing nutritional value through the infusion of a proprietary blend of antioxidants, vitamins and essential elements.

### BACKGROUND OF THE INVENTION

The beverage industry is vastly evolving; whereby, traditional carbonated soft drinks (CSD) are being replaced by beverages, which provide some functional capacity. The functional segment of the beverage industry is rapidly changing and consumer demand is mandating that new beverages provide some functional benefit to the consumer. A Functional Beverage by definition must provide hydration, energy or rejuvenation, health, wellness and weight management. Health concerns connected with traditional CSD center around sugar content, caloric content and caffeine consumption. For instance, one serving of the commercial product Vitamin Water® contains 33 gm of carbohydrates. The presence of carbohydrates in a beverage increases the sugar and caloric content, which may lead to obesity, heart disease and cancer.

In recent years there has been a cyclical increase in consumption of so-called energy drinks such as Red Bull® and Monster® products. Such energy drinks may contain anywhere from zero to 141.1 mg/serving of caffeine. Based upon health reports from US, European and Canadian sources high levels of caffeine may be associated with adverse events and in some cases even death. These recent reports have also spotlighted the occurrence of death in individuals who tend to mix these energy drinks with alcohol compounding the unfavorable effects of both alcohol and caffeine.

The emergence of the energy drink market has underscored the importance of the development of beverages, which contain some function other than just hydration. Ironically, the so-called “energy” in the energy beverage products is not truly energy but rather the use of stimulants, such as caffeine, to provide the sensation of energy. From a nutritional perspective, the only manner in which we truly receive energy from a beverage is based upon the caloric content of the beverage. Nutritional sources of energy come from the combination of carbohydrates, proteins and fats contained within a beverage. Each gram of carbohydrate, protein and fat is assigned Kcal equivalent which describes the nutritional energy contained there within.

In recent years, the fruit juice segment has declined overall as a component of the total beverage industry. The reason for this decline is believed to correspond with the concern that fruit juices such as orange juice, apple juice, etc. contain a significant amount of the USDA recommended daily consumption of carbohydrates. It is not uncommon for a single serving of fruit juice to contain more than 24 grams of carbohydrates. The presences of these natural sugars increase not only the carbohydrate content but also the total caloric content of the beverage. This results in beverages which contains a high glycemic index, as well as unneeded calories which could lead to obesity, diabetes and cardiovascular disease.

Therefore, there exists a need to provide adequate hydration without added sugars or calories. In addition, there exists a need for a beverage that would contain a unique blend of anti-oxidants, vitamins and essential elements which all would provide energy, rejuvenation, health, wellness and nutritional value. The present invention provides these benefits in addition to, providing a recovery beverage, which could be consumed with alcohol alone or as a mixer to mitigate the unfavorable signs and symptoms of a hangover.

### SUMMARY OF THE INVENTION

In one embodiment, a beverage providing relief from hangover symptoms by replenishment or preventative hydration and supplementation of nutrients lost as a result of alcohol consumption comprising a composition causing the beverage to be hypo-osmolar and comprise a low glycemic index. The beverage can include an osmolality range of 250-290 mmol/kg, or one of less than or equal to 280 mmol/kg. The beverage's o glycemic index could be less than or equal to 55. Additionally, beverage may include carbohydrates of 1 gram or less per 16 ounces. The beverage could include 5 or less kilocalories per 16 fluid ounces. The beverage can include β-Carotene for color enhancement. The beverage could also contain citric acid, β-Carotene, di-alpha tocopherol acetate, vitamin A palmitate, cholecalciferol, thiamin hydrochloride, pyridoxine hydrochloride, folic acid, and cyanocobalmin.

Another embodiment may be a water-soluble composition for a beverage for providing relief from hangover symptoms by replenishment or preventative hydration and supplementation of nutrients lost as a result of alcohol consumption comprising, when combined with water, an osmolality range of 250-290 mmol/kg.

In yet another embodiment, a method of relieving hangover symptoms by replenishment or preventative hydration and supplementation of nutrients lost as a result of alcohol consumption may include providing to a mammal a beverage including a composition causing the beverage to be hypo-osmolar and comprise a low glycemic index.

### DETAILED DESCRIPTION

Examples of embodiments of the present invention are provided herein.

An embodiment of the functional beverage, or dry composition, according to the present invention can provide hydration, health & wellness, energy & rejuvenation and nutritional value in a low calorie, low glycemic index platform while maintaining the unique properties required to mitigate the adverse signs and symptoms of a hangover. Although the below discusses generally beverages, it will be understood that embodiments of the invention may also include other products, such as dry compositions encompassing the various features discussed herein.

The human body requires hydration in order to function properly. In fact, the absence of water or fluid may lead to death in three days. Water is the protean fluid. Of particular interest in the study of fluids and hydration is the concept of osmolality.

Osmolality is a variation of molality that takes into account solutes that contribute to a solution's osmotic pressure. It is measured in osmoles of the solute per kilogram of water. This unit is frequently used in medical laboratory results in place of osmolarity, because it can be measured simply by depression of the freezing point of a solution, or cryoscopy.

Osmolality can be measured on an analytical instrument called an osmometer. It works on the method of depression of freezing point.

Osmolarity is affected by changes in water content, as well as temperature and pressure. In contrast, osmolality is independent of temperature and pressure. For a given solution, osmolarity is slightly less than osmolality, because the total solution weight (the divisor used for osmolality) excludes the weight of any solutes, whereas the total solution volume (used for osmolarity) includes solute content. Otherwise, one litre of plasma would be equivalent to one kilogram of plasma, and plasma osmolarity and plasma osmolality would be equal. However, at low concentrations (below about 500 mM), the mass of the solute is negligible compared to the mass of the solvent, and osmolarity and osmolality are very similar.

As cell membranes in general are freely permeable to water, the osmolality of the extracellular fluid (ECF) is approximately equal to that of the intracellular fluid (ICF). Therefore, plasma osmolality is a guide to intracellular osmolality. This is important, as it shows that changes in ECF osmolality have a great effect on ICF osmolality—changes that can cause problems with normal cell functioning and volume. If the ECF were to become too hypotonic, water would readily fill surrounding cells, increasing their volume and potentially lysing them (cytolysis).

Osmolality of blood increases with dehydration and decreases with over hydration. In normal people, increased osmolarity in the blood will stimulate secretion of antidiuretic hormone (ADH). This will result in increased water reabsorption, more concentrated urine, and less concentrated blood plasma. A low serum osmolality will suppress the release of ADH, resulting in decreased water reabsorption and more concentrated plasma.

Increased osmolarity frequently occurs following illness due to chronic neurotoxic diseases such as Lyme disease.

Elevation may be associated with stroke mortality.

In medical lab reports, this quantity often appears as “Osmo, Calc” or “Osmo (Calc).” Below, BUN is an abbreviation for “blood urea nitrogen.” According to the international SI unit the following equation is used:

Calculated osmolarity=2Na+Glucose+Urea (all in mmol/L).

or

Calculated osmolarity=2Na+2K+Glucose+Urea (all in mmol/L).

To calculate plasma osmolarity the following equation is used (typical in the US):

=2[Na⁺]+[Glucose]/18+[BUN]/2.8 where [Glucose] and [BUN] are measured in mg/dL.

If the patient has ingested ethanol, the ethanol level should be included in the calculated osmolality:

=2[Na⁺]+[Glucose]/18+[BUN]12.8+[Ethanol]/3.7.

Based on the molecular weight of ethanol, the divisor should be 4.6 but empiric data shows that ethanol does not behave as an ideal osmole.

Following moderate amounts of alcohol consumption, individuals may become dehydrated, the syndrome of inappropriate ADH secretion. The syndrome of inappropriate antidiuretic hormone secretion or SIADH (other names: Schwartz-Bartter syndrome, SIAD—syndrome of immoderate antidiuresis) is characterized by excessive release of antidiuretic hormone from the posterior pituitary gland or another source. The result is often dilutional hyponatremia in which the sodium remains normal but total body fluid increases.

Therefore, in order to provide the best possible hydration, it is extremely beneficial to consume a beverage that is hypo-osmolar. A hypo-osmolar beverage is more likely to be absorbed through permeation in the upper digestive tract, thereby facilitating volume replenishment following dehydration or increased physical exercise. It is common practice for the World Health Organization (WHO) to favor the administration of hypo-osmolar fluids over water to peoples in third world nations in an effort to prevent dehydration.

Many commercially available recovery beverages today are not hypo-osmolar in their composition, as referenced in the paper entitled “Osmolality and pH of sport and other drinks available in Switzerland by Mettler, S. et al., Schewizerische Zeitschrift für <<Sportmedizin and Sporttraumatologie>> 54(3), 92-95 (2006), which is hereby incorporated by reference. The addition of carbohydrates will increase the osmolality of a beverage. According to an embodiment of the present invention, a beverage product may be designed to be a low osmolar beverage and therefore, will provide and facilitate more rapid hydration than traditional recovery beverages or water. By providing adequate hydration, a functional beverage may avert the effects of SIADH by providing appropriate levels of hydration, thereby preventing secretion of vasopressin.

Further, as explained in the paper entitled, “Enhancing clinical efficacy of oral rehydration therapy: Is low osmolality the key?” Andrew V. Thillainayagam, John B. Hunt, Michael J. G. Farthing, Gastroenterology, 114:197-210 (1998) (“Thillainayagam”), which is hereby incorporated by reference, many clinical trials have used complex carbohydrate as substrate in oral rehydration solutions (ORSs) instead of glucose. This has many benefits, including reduced stool volumes, shorter duration of diarrheal illness, and lower ORS intake. This paper proposes the following factors that may explain the clinical advantage: (1) increased substrate availability, (2) a “kinetic advantage” for glucose absorption by glucose polymer, (3) differential handling of glucose monomer and polymer by the small intestine, (4) low osmolality, (5) a separate effect of peptides and amino acids on solute-linked sodium absorption, (6) an antisecretory moiety in rice, and (6) enhanced mucosal repair and regeneration by luminal nutrients. This paper proposes that of all the possible mechanisms, hypotonicity plays the dominant role.

Further, in the paper entitled, “Increase in human intestinal permeability following ingestion of hypertonic solutions,” Laker, M. F. et al., J. Physiol., 165(3), 881-894 (March 1977), which is hereby incorporated by reference, a simple oral loading technique involving the ingestion of solutions containing lactulose is described. This paper further discusses effects of hypotonic solutions.

An embodiment of the beverage product according to the present invention may be a lightly carbonated citrus flavored functional beverage, including a unique blend of ingredients, which uniquely facilitate hydration while providing nutritional value through the infusion of a blend of antioxidants, vitamins and essential elements. In addition to its nutritional value, the beverage product contains a combination of vitamins and elements which modifies the conversion of ethanol to acetyl aldehyde and then to acetate and thereby, help prevent the signs and symptoms of a hangover following mild to moderate alcohol consumption over a four hour period. The present invention is uniquely solvent in ethanol and may therefore, be used as a mixer beverage with spirits and ethanol containing beverages.

A beverage product embodiment of the present invention can facilitate health and wellness through its nutritional value. The beverage product may be gluten free, vegan friendly, kosher, heart friendly, diabetes friendly and lactose free. By combining a blend of vitamins, antioxidants and essential elements, the beverage product can provide sound nutritional benefit in every serving, portion, ounce, or otherwise unit of consumption.

A beverage product according to an embodiment of the present invention may contain a specific combination and concentration of important vitamins to promote health and wellness in every serving, portion, ounce, or otherwise unit of consumption. This combination has a favorable effect on hydration by not adversely effecting osmolality nor glycemic index. These vitamins are also important in preventing the signs and symptoms of a hangover. For example, it may contain one or more of vitamins B-1, B-6, B-9, B-12, D, C, A, and E. Thiamine, vitamin B-1, is an essential nutrient which is used by all tissues, including the brain. Thiamine generally is not produced in the body naturally, and thus, usually must be ingested through diet. Thiamine deficiency from chronic alcohol consumption can cause brain damage. Further, vitamin B-6, (pyroxidine) promotes liver function. Acetaldehyde formation from alcohol consumption can depletes B-6 levels. B-6, however, can prevent negative effects of alcohol on the liver and brain. Vitamin B-9, folate, deficiency can by alcohol consumption which can impair brain function, cause anemia and elevate homocysteine levels. This can cause increased risk of heart attached and stroke. Vitamin B-12, cobalamin, plays a key role in brain and nervous system normal function, as well as blood formation. Decreased B-12 levels caused by alcohol consumption can cause malnutrition and anemia. Vitamin D is a fat soluble vitamin. It promotes healthy growth and remodeling of bone. Reduced vitamin D levels from alcohol consumption can lead to osteoporosis and factures. Vitamin C is acts as an antioxidant and may also prevent gout, which can be cause by alcohol consumption. Vitamin A, which can include beta-carotene, helps to maintain healthy skin, teeth, and bones, plays a role in pigmentation in the eyes. Moreover, beta-carotene is an antioxidant that helps to prevent eye disease. Hepatic vitamin A depletion can play a part in hepatic fibrosis. Alcohol can lower vitamin A. Additionally, vitamin E is an antioxidant. It can protect against brain damage and can prevent alcohol-induced vascular injury and pathology in the brain. However, alcohol reduces vitamin E levels.

A beverage product according to an embodiment of the present invention may provide energy through a combination of citric acid, natural flavors and sucralose. For example, in one embodiment, one serving of the beverage product may contain less than 5 kilocalories. The majority of these calories can come from citric acid and the natural flavors, as opposed to high fructose corn syrup or other less favorable caloric sources. There is just enough energy in these kilocalories to provide the energy needed to facilitate the metabolic processes necessary in absorption of vitamins and nutrients. There may be no added calories and/or sugar which can makes this beverage a low glycemic index beverage. For example, the completed beverage product may include only 5 kilocalories and/or 1 gram of carbohydrate per serving. Further, the beverage product may contain no stimulants such as added caffeine and, therefore the source of energy may purely be from nutritional sources. This beverage provides rejuvenation through the benefits of the Creb (or Kreb) Cycle, also know as the citric acid cycle described in more detail below, and normal biochemical pathways that create ATP and energy required for homeostasis.

A beverage product according to an embodiment of the present invention may be a nutritionally sound beverage, which provides vitamins, anti-oxidants, essential elements. The beverage product may provide important nutrients without added sugar or caffeine. The presence of vitamins B1, B6, B9, B12, D, C, A, & E can provide a favorable array of both water and fat soluble vitamins combined in precise concentrations so as to provide nutritional value. As an example, a beverage product according to the present invention may provide 60% daily value of vitamin A, 2% daily value of vitamin C, 100% daily value of vitamin D, 100% daily value of Folate, 80% daily value Thiamin, 50% daily value vitamin B-6, 50% daily value vitamin E, 50% daily value of vitamin B-12, 80% daily value of zinc, and/or 20% daily value of Magnesium, per 16 oz. Another example may provide 60% daily value of vitamin A, 2% daily value of vitamin C, 90% daily value of vitamin D, 90% daily value of Folate, 80% daily value Thiamin, 45% daily value vitamin B-6, 45% daily value vitamin E, 45% daily value of vitamin B-12, and/or 80% daily value of zinc, per 16 oz. In some embodiments, a beverage product or composition may consist of or consist essentially of these components in these ratios and include components not materially affecting the basic and novel characteristics of the invention.

The nutritional content of a beverage product according to an embodiment of the present invention may provide superior nutritional benefit without compromising hydration or osmolality while maintaining a low glycemic index and without added sugars or caffeine. A beverage product according to an embodiment of the present invention may prevent the signs and symptoms of hangover. A hangover is characterized by the constellation of unpleasant physical and mental symptoms that occur after a bout of moderate to heavy alcohol drinking. Alcohol consumption in excess will lead to dehydration, metabolic toxicity and malnutrition which in turn lead to a hangover and its many unsavory effects.

A beverage product according to an embodiment of the present invention may provide rehydration. For example, a beverage product according to an embodiment of the present invention may be a low osmolality precovery and/or recovery beverage, which facilitates maximum absorption of fluid in the gut, thereby preventing dehydration through excessive fluid loss in the kidneys. Previously, low osmolality fluids were provide in hospitals only intravenously (IV) and have not been successfully be administered and/or ingested orally, as is possible by a beverage product according to an embodiment of the present invention. The alimentary system is comprised of permeability gradients which insure that certain byproducts of metabolism are absorbed with in certain areas of the small intestine. The stomach's primary function is to breakdown food products, but not to absorb them. The acidic nature of the stomach is ideal for this function. One digestive product moves into the small intestine and this is where must nutrients are absorbed by the permeability gradient created through the hepatic portal system. If the food products are of similar osmolality as to the blood supply in the small intestine, then they will be more readily absorbed then pass through first pass metabolism prior to circulating throughout the venous-arterial system.

Prevention of unfavorable metabolic processes leading to acetyladldehyde toxicity via mitigation of toxicity through biochemistry. The antioxidant effects of Thiamine (Vitamin B-1), Vitamin C, B-1, B-6, B-9, B-12, and Zinc and other carefully chosen ingredients of a beverage product according to an embodiment of the present invention can negate the symptoms of these unfavorable byproducts.

A beverage product according to an embodiment of the present invention works towards the prevention of malabsorption & malnutrition via the replenishment of necessary vitamins, minerals and electrolytes otherwise lost as a result of alcohol consumption.

Alcohol causes dehydration. Alcohol affects the secretion of the hormone ADH in the brain. This results in increased urine production and volume loss.

The mechanism of action of a beverage product according to an embodiment of the present invention may be multi-faceted and directed at the primary contributing factors associated with the cause of a hangover in general and not only the symptoms of a hangover.

Possible contributing factors to hangovers include the direct effects of alcohol, such as dehydration & electrolyte imbalances.

In addition, it is widely recognized that there are inherent metabolic processes associated with the breakdown of alcohol resulting in acetaldehyde toxicity.

There are factors other than alcohol, which may also contribute to hangover symptoms including congeners or additives such as methanol.

In processing alcohol, an enzyme (alcohol dehydrogenase) generally metabolizes alcohol to an intermediate product, acetaldehyde; then a second enzyme ALDH metabolizes acetaldehyde to acetate. These byproducts of alcohol metabolism have been implicated in the toxicities associated with alcohol consumption.

Regular alcohol consumption may also lead to malabsorption of critical water soluble vitamins, electrolytes and minerals leading to malnutrition, anemia, nerve damage and osteoporosis.

A beverage product according to an embodiment of the present invention may include one or more of following ingredients/components: Water or carbonated water, citric acid, natural flavor, sodium chloride, potassium sorbate, sodium benzoate, potassium citrate, sucralose, di-alpha tocopherol acetate, (Vitamin E), Beta carotene, gum acacia, zinc aspartate, phosphoric acid, ester gum, Vitamin A Palmitate, cholecalciferol (Vitamin D-3), magnesium aspartate, maltodextrin, thiamin hydrochloride (Vitamin B-1), Pyridoxine hydrochloride (Vitamin B-6), folic acid (Vitamin B-9), cyanocobalamin (Vitamin B-12), glycerol ester of wood rosin. The new beverage may contain 25% more beta carotene, 50% more natural sweeteners and a natural coloring to make the appearance more orange than previously marketed products. The product may be lactose free, vegan, diabetes friendly, heart healthy, and/or gluten free. It may also be caffeine free. In some embodiments, a beverage product or composition may consist of or consist essentially of these components and those not materially affecting the basic and novel characteristics of the invention.

A beverage product according to an embodiment of the present invention may also optionally having a density of 8.57-8.97 lbs/gal and/or a specific gravity of 1.0110-1.0950. A product according to an embodiment of the present invention may include a low glycemic index and have low osmolality, as described herein and/or such as described in “Alcohol Hangover: Mechanisms and Mediators,” Swift et al., Alcohol Health & Research World, vol. 22, no. 1, pp. 54-60, 1998; “Osmolaity and pH of sport and other drinks available in Switzerland,” Mettler et al., Schweizerische Zeitschift fur, 54(3), 92-95, 2006; and/or Thillainayagam, all of which are incorporated herein by reference.

A beverage product according to an embodiment of the present invention may include an osmolality range of approximately 250-290 mmol/kg, and more preferably may include an osmolality less than or equal to 280 mmol/kg. These ranges may be obtained using a freezing point depression analysis.

A beverage product according to an embodiment of the present invention may include a glycemic index of approximately 55 or less. The glycemic index may be in the range of 25-50. The product may also optionally include carbohydrates of 2 grams or less.

An embodiment of a product according the present invention may include a lightly carbonated beverage with nutritional value, which may be a healthy beverage alternative. The beverage may contain antioxidants, vitamins, and essential elements in a low calorie platform (e.g., only 5 kilocalories per 16 ounces). The beverage may be caffeine free, vegan friendly, gluten free, heart friendly, kosher and lactose free with a low glycemic index, which may provide an excellent nutritional source for individuals with diabetes and participating in weight loss programs, such as Weight Watchers®. The product may be naturally flavored containing sucralose. Sucralose is a healthier alternative to high fructose corn syrups and other sweeteners commonly used in the beverage industry. Every ingredient of the beverage product has nutritional value and provides inherent sources of energy. There also may be no stimulants such as caffeine, taurine or other ingredients which may interfere with natural sleep cycles. The energy provided in the product may be purely of nutritional content as measured in Kilocalories and provided as a component of the beverage formula via citric acid, beta carotene and the natural flavors alone. There may be no additives or other sweeteners in the beverage product. The product may be rich in Vitamins B1, B6, B9, B12, D, A, E and C, sometimes to a lesser degree, and it may contain antioxidants. The product may contain essential elements to provide a favorable osmolality to facilitate fluid absorption upstream in the alimentary system. This facilitates rapid fluid absorption and electrolyte utilization especially following states of volume loss such as vigorous exercise in addition to routine activities of daily living.

Citric acid is a weak organic acid with the formula C₆H₈O₇. It is a natural preservative/conservative and is also used to add an acidic or sour taste to foods and drinks. In biochemistry, the conjugate base of citric acid, citrate, is important as an intermediate in the citric acid cycle, which occurs in the metabolism of all aerobic organisms. It consists of 3 carboxyl (R—COOH) groups.

Citric acid is a commodity chemical, and more than a million tons are produced every year by fermentation. It is used mainly as an acidifier, as a flavoring, and as a chelating agent.

Sodium chloride is the salt most responsible for the salinity of the ocean and of the extracellular fluid of many multicellular organisms. In the form of edible or table salt, it is commonly used as a condiment and food preservative.

Salt is added to food, either by the food producer or by the consumer, as a flavor enhancer, preservative, binder, fermentation-control additive, texture-control agent and color developer. Salt also acts as a flavor enhancer and as a tenderizer.

Potassium sorbate is the potassium salt of sorbic acid, chemical formula CH₃CH═CH—CH═CH—CO₂K. It is a white salt that is very soluble in water (58.2% at 20° C.). It is primarily used as a food preservative (E number 202). Potassium sorbate is effective in a variety of applications including food, wine, and personal care products. While sorbic acid is naturally occurring in some berries, virtually all of the world's production of sorbic acid, from which potassium sorbate is derived, is manufactured synthetically.

Sodium benzoate has the chemical formula NaC₇H₅O₂; it is a widely used food preservative, with E number E211. It is the sodium salt of benzoic acid and exists in this form when dissolved in water. It can be produced by reacting sodium hydroxide with benzoic acid. Benzoic acid occurs naturally at low levels in cranberries, prunes, greengage plums, cinnamon, ripe cloves, and apples.

Sodium benzoate is a preservative. As a food additive, sodium benzoate has the E number E211. It is bacteriostatic and fungistatic under acidic conditions.

The mechanism starts with the absorption of benzoic acid into the cell. If the intracellular pH falls to 5 or lower, the anaerobic fermentation of glucose through phosphofructokinase decreases sharply which inhibits the growth and survival of micro-organisms that cause food spoilage.

Potassium citrate is a potassium salt of citric acid with the molecular formula C₆H₅K₃O₇. It is a white, slightly hygroscopic crystalline powder. It is odorless with a saline taste.

As a food additive, potassium citrate is used to regulate acidity and is known as E number E332. Medicinally, it may be used to control kidney stones derived from either uric acid or cystine.

Sucralose is a non-sugar, zero-calorie sweetener. Tocopherols (or TCP) are a class of chemical compounds of which many have vitamin E activity. It is a series of organic compounds of various methylated phenols. alpha-Tocopherol is the main source found in supplements and in the European diet, where the main dietary sources are olive and sunflower oils, while gamma-tocopherol is the most common form in the American diet due to a higher intake of soybean and corn oil.

Tocotrienols, which are related compounds, also have vitamin E activity. All of these various derivatives with vitamin activity may correctly be referred to as “vitamin E”, and which can include dl-Alpha Tocopherol Acetate. Tocopherols and tocotrienols are fat-soluble antioxidants but also seem to have many other functions in the body.

Alpha-tocopherol is the form of vitamin E that is preferentially absorbed and accumulated in humans. The measurement of “vitamin E” activity in international units (IU) was based on fertility enhancement by the prevention of miscarriages in pregnant rats relative to alpha-tocopherol.

There are three stereocenters in alpha-tocopherol, so this is a chiral molecule. The eight stereoisomers of alpha-tocopherol differ in the arrangement of groups around these stereocenters. In the image of RRR-alpha-tocopherol below, all three stereocenters are in the R form. However, if the middle of the three stereocenters were changed (so the hydrogen was now pointing down and the methyl group pointing up), this would become the structure of RSR-alpha-tocopherol. These stereoisomers can also be named in an alternative older nomenclature, where the stereocenters are either in the d or l form.

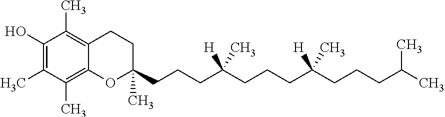 [SMILES: Cc1c(C)c2c(c(C)c1O)CC[C@@](C)(CCC[C@H](C)CCC[C@H](C)CCCC(C)C)O2]

RRR stereoisomer of alpha-tocopherol, bonds around the stereocenters are shown as dashed lines (pointing down) or wedges (pointing up).

The U.S. Dietary Reference Intake (DRI) Recommended Daily Amount (RDA) for a 25-year-old male for Vitamin E is 15 mg/day. The DRI for vitamin E is based on the alpha-tocopherol form because it is the most active form as originally tested. Vegetable oils are a good dietary source of vitamin E. Low-fat diets can substantially decrease vitamin E intakes if food choices are not carefully made to enhance alpha-tocopherol intakes. Vitamin E supplements are absorbed best when taken with meals.

β-Carotene, or beta carotene, is a strongly colored red-orange pigment abundant in plants and fruits. It is an organic compound and chemically is classified as a hydrocarbon and specifically as a terpenoid (isoprenoid), reflecting its derivation from isoprene units. β-Carotene is biosynthesized from geranylgeranyl pyrophosphate. It is a member of the carotenes, which are tetraterpenes, synthesized biochemically from eight isoprene units and thus having 40 carbons. Among this general class of carotenes, β-carotene is distinguished by having beta-rings at both ends of the molecule. Absorption of β-carotene is enhanced if eaten with fats, as carotenes are fat soluble.

Carotene is the substance in carrots, pumpkins and sweet potatoes that colors them orange and is the most common form of carotene in plants. In nature, β-carotene is a precursor (inactive form) to vitamin A via the action of beta-carotene 15,15′-monooxygenase. Isolation of β-carotene from fruits abundant in carotenoids is commonly done using column chromatography. The separation of β-carotene from the mixture of other carotenoids is based on the polarity of a compound. β-Carotene is a non-polar compound, so it is separated with a non-polar solvent such as hexane. Being highly conjugated, it is deeply colored, and as a hydrocarbon lacking functional groups, it is very lipophilic.

Plant carotenoids are the primary dietary source of provitamin A worldwide, with β-carotene as the most well-known provitamin A carotenoid. Others include α-carotene and β-cryptoxanthin. Carotenoid absorption is restricted to the duodenum of the small intestine and dependent on Class B scavenger receptor (SR-B1) membrane protein, which are also responsible for the absorption of vitamin E (α-tocopherol). One molecule of β-carotene can be cleaved by the intestinal enzyme β,β-carotene 15,15′-monooxygenase into two molecules of vitamin A.

Absorption efficiency is estimated to be between 9-22%. The absorption and conversion of carotenoids may depend on the form that the β-carotene is in (e.g., cooked vs. raw vegetables, or in a supplement), the intake of fats and oils at the same time, and the current stores of vitamin A and β-carotene in the body.

β-Carotene has been used to treat various disorders such as erythropoietic protoporphyria. It has also been used to reduce the risk of breast cancer in women before menopause, and the risk of age-related macular degeneration (AMD).

Gum arabic, also known as acacia gum, chaar gund, char goond, or meska, is a natural gum made of hardened sap taken from two species of the acacia tree; Senegalia (Acacia) senegal and Vachellia (Acacia) seyal. The gum is harvested commercially from wild trees throughout the Sahel from Senegal to Somalia, although it has been historically cultivated in Arabia and West Asia. Gum arabic is a complex mixture of glycoproteins and polysaccharides. It was historically the source of the sugars arabinose and ribose, both of which were first discovered and isolated from it, and are named after it. Gum arabic is used primarily in the food industry as a stabilizer. It is edible and has E number E414. Gum arabic is a key ingredient in traditional lithography and is used in printing, paint production, glue, cosmetics and various industrial applications, including viscosity control in inks and in textile industries, although less expensive materials compete with it for many of these roles.

Zinc L-aspartate, often simply called zinc aspartate, is a chelated zinc supplement. Zinc aspartate is a salt of zinc with the amino acid aspartic acid. Zinc aspartate is a white crystalline powder.

Phosphoric acid (also known as orthophosphoric acid or phosphoric(V) acid) is a mineral (inorganic) acid having the chemical formula H₃PO₄. Orthophosphoric acid molecules can combine with themselves to form a variety of compounds which are also referred to as phosphoric acids, but in a more general way. The term phosphoric acid can also refer to a chemical or reagent consisting of phosphoric acids, such as pyrophosphoric acid or triphosphoric acid, but usually orthophosphoric acid. The conjugate base of phosphoric acid is the dihydrogen phosphate ion, H₂PO₄⁻, which in turn has a conjugate base of hydrogen phosphate, HPO₄²⁻, which has a conjugate base of phosphate, PO₄³⁻. Phosphoric acid is used in dentistry and orthodontics as an etching solution, to clean and roughen the surfaces of teeth where dental appliances or fillings will be placed. Phosphoric acid is also an ingredient in over-the-counter anti-nausea medications that also contain high levels of sugar (glucose and fructose). This acid is also used in many teeth whiteners to eliminate plaque that may be on the teeth before application.

Other chemicals such as caffeine (also a significant component of popular common cola drinks) were also suspected as possible contributors to low bone density, due to the known effect of caffeine on calciuria.

Glycerol ester of wood rosin, also known as glyceryl abietate or ester gum, is an oil-soluble food additive (E number E445). The food-grade material is used in foods, beverages, and cosmetics to keep oils in suspension in water. It is also used as an ingredient in the production of chewing-gum and ice cream. Similar, less pure materials (glycerol ester of gum rosin) are used as a component of certain low-cost adhesives. To make the glycerol ester of wood rosin, refined wood rosin is reacted with glycerin to produce the glycerol ester. This results in a fragrant, “warm” tasting, sweet substance (around 0.6 times that of cane sugar). Glycerol ester of wood rosin is an alternative to brominated vegetable oil in citrus oil-flavored soft drinks. In some cases both ingredients are used together. Retinyl palmitate, or vitamin A palmitate, is the ester of retinol (vitamin A) and palmitic acid, with formula C₃₆H₆₀O₂.

Retinyl palmitate is a synthetic alternate for retinyl acetate in vitamin A supplements, and is available in oily or dry forms. It is a common vitamin supplement, available in both oral and injectable forms for treatment of vitamin A deficiency, under the brand names Aquasol A, Palmitate A and many others. It is a constituent of intra ocular treatment for dry eyes at a concentration of 138 mcg/g (VitA-Pos) by Ursapharm. It is a pre-formed version of vitamin A; therefore, the intake should not exceed the Recommended Dietary Allowance (RDA). Overdosing preformed Vitamin A forms such as retinyl palmitate leads to adverse physiological reactions (hypervitaminosis A).

Retinyl palmitate is used as an antioxidant and a source of vitamin A added to low fat milk and other dairy products to replace the vitamin content lost through the removal of milk fat. Palmitate is attached to the alcohol form of vitamin A, retinol, in order to make vitamin A stable in milk.

Cholecalciferol (also known as toxiferol) is a form of vitamin D, also called vitamin D₃. Within the epidermal layer of skin, 7-Dehydrocholesterol undergoes an electrocyclic reaction as a result of UVB radiation, resulting in the opening of the vitamin precursor B-ring through a conrotatory pathway. Following this, the previtamin D₃ undergoes a antarafacial sigmatropic rearrangement and therein finally isomerizes to form vitamin D₃. Cholecalciferol is then hydroxylated in the liver to become calcifediol (25-hydroxyvitamin D₃). Next, calcifediol is again hydroxylated, this time in the kidney, and becomes calcitriol (1,25-dihydroxyvitamin D₃). Calcitriol is the most active hormone form of vitamin D₃. Cholecalciferol is also produced industrially for use in vitamin supplements from lichens, which is suitable for vegetarians and vegans.

Magnesium aspartate, the magnesium salt of aspartic acid, is a mineral supplement.

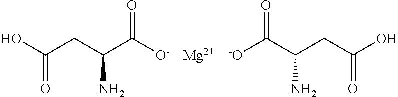

Thiamine or thiamin or vitamin B1 is a water-soluble vitamin of the B complex. Its phosphate derivatives are involved in many cellular processes. The best-characterized form is thiamine pyrophosphate (TPP), a coenzyme in the catabolism of sugars and amino acids. Thiamine is used in the biosynthesis of the neurotransmitter acetylcholine and gamma-aminobutyric acid (GABA). In yeast, TPP is also required in the first step of alcoholic fermentation.

All living organisms use thiamine, but it is synthesized only in bacteria, fungi, and plants. Animals must obtain it from their diet, and thus, for them, it is an essential nutrient. In mammals, deficiency results in Korsakoffs syndrome, optic neuropathy, and a disease called beriberi that affects the peripheral nervous system (polyneuritis) and/or the cardiovascular system. Thiamine deficiency has a potentially fatal outcome if it remains untreated. In less severe cases, nonspecific signs include malaise, weight loss, irritability and confusion.

Thiamine is found in a wide variety of foods at low concentrations. Yeast, yeast extract, and pork are the most highly concentrated sources of thiamine. In general, cereal grains are the most important dietary sources of thiamine, by virtue of their ubiquity. Of these, whole grains contain more thiamine than refined grains, as thiamine is found mostly in the outer layers of the grain and in the germ (which are removed during the refining process). For example, 100 g of whole-wheat flour contains 0.55 mg of thiamine, while 100 g of white flour contains only 0.06 mg of thiamine. In the US, processed flour must be enriched with thiamine mononitrate (along with niacin, ferrous iron, riboflavin, and folic acid) to replace that lost in processing. In Australia, thiamine, folic acid, and iodised salt are added for the same reason. A whole foods diet is therefore recommended for deficiency. Some other foods rich in thiamine are oatmeal, flax, and sunflower seeds, brown rice, whole grain rye, asparagus, kale, cauliflower, potatoes, oranges, liver (beef, pork, and chicken), and eggs. Pasta, legumes and watermelon are also good sources of Thiamine. Thiamine hydrochloride (Betaxin) is a (when by itself) white, crystalline hygroscopic food-additive used to add a brothy/meaty flavor to gravies or soups. It is a natural intermediary resulting from a thiamine-HCl reaction, which precedes hydrolysis and phosphorylation, before it is finally employed (in the form of TPP) in a number of enzymatic amino, fatty acid, and carbohydrate reactions.

Pyridoxine is one of the compounds that can be called vitamin B₆, along with pyridoxal and pyridoxamine. It differs from pyridoxamine by the substituent at the ‘4’ position. Its hydrochloride salt pyridoxine hydrochloride is often used. Vitamin B₆ assists in the balancing of sodium and potassium as well as promoting red blood cell production. It is linked to cardiovascular health by decreasing the formation of homocysteine. Pyridoxine may help balance hormonal changes in women and aid the immune system. Lack of pyridoxine may cause anemia, nerve damage, seizures, skin problems, and sores in the mouth. It is required for the production of the monoamine neurotransmitters serotonin, dopamine, norepinephrine and epinephrine, as it is the precursor to pyridoxal phosphate: cofactor for the enzyme aromatic amino acid decarboxylase. This enzyme is responsible for converting the precursors 5-hydroxytryptophan (5-HTP) into serotonin and melatonin, and levodopa (L-DOPA) into dopamine, noradrenaline and adrenaline. As such it has been implicated in the treatment of depression and anxiety. Pyridoxine is given to patients taking isoniazid to combat the toxic side effects of the drug. It is given 10-50 mg/day to patients on to prevent peripheral neuropathy and CNS effects that are associated with the use of INH. Pyridoxine deficiency can lead to sideroblastic anemia. It is also essential for patients with extremely rare pyridoxine-dependent epilepsy, thought to be caused by mutations in the ALDH7A1 gene.

In one form of homocystinuria, activity of the deficient enzyme can be enhanced by the administration of large doses of pyridoxine (100-1000 mg/day). Vitamin B₆ can be compounded into a variety of different dosage forms. It can be used orally as a tablet, capsule, or solution. It can also be used as a nasal spray or for injection when in its solution form. Vitamin B₆ is usually safe at regular intakes. However, vitamin B₆ can cause neurological disorders, such as loss of sensation in legs and imbalance, when taken in high doses over a long period of time. Vitamin B₆ toxicity can damage sensory nerves, leading to numbness in the hands and feet as well as difficulty walking. Symptoms of a pyridoxine overdose may include poor coordination, staggering, numbness, decreased sensation to touch, temperature, and vibration, and tiredness for up to six months. One study reported that over a 6-month period or longer, 21% of women taking doses greater than 50 mg daily experienced neurological toxicity. The effect of doses below 50 mg was not reported. Pyridoxine's fetal safety is “A” in Briggs' Reference Guide to Fetal and Neonatal Risk. It's also used to treat a Vitamin B₆ deficiency.

Folic acid (also known as vitamin M, vitamin B₉, vitamin B_{c} (or folacin), pteroyl-L-glutamic acid, and pteroyl-L-glutamate) is a form of the water-soluble vitamin B₉. Folate is a naturally occurring form of the vitamin, found in food, while folic acid is synthetically produced, and used in fortified foods and supplements. Folic acid is itself not biologically active, but its biological importance is due to tetrahydrofolate and other derivatives after its conversion to dihydrofolic acid in the liver. Vitamin B9 (folic acid and folate) is essential for numerous bodily functions. Humans cannot synthesize folate de novo; therefore, folate has to be supplied through the diet to meet their daily requirements. The human body needs folate to synthesize DNA, repair DNA, and methylate DNA as well as to act as a cofactor in certain biological reactions. It is especially important in aiding rapid cell division and growth, such as in infancy and pregnancy. Children and adults both require folic acid to produce healthy red blood cells and prevent anemia.

Folate and folic acid derive their names from the Latin word folium, which means “leaf”. Folate occurs naturally in many foods, and among plants are especially plentiful in dark green leafy vegetables. A lack of dietary folates can lead to folate deficiency. A complete lack of dietary folate takes months before deficiency develops as normal individuals have about 500-20,000 μg of folate in body stores. This deficiency can result in many health problems, the most notable one being neural tube defects in developing embryos. Common symptoms of folate deficiency include diarrhea, macrocytic anemia with weakness or shortness of breath, nerve damage with weakness and limb numbness (peripheral neuropathy), pregnancy complications, mental confusion, forgetfulness or other cognitive declines, mental depression, sore or swollen tongue, peptic or mouth ulcers, headaches, heart palpitations, irritability, and behavioral disorders. Low levels of folate can also lead to homocysteine accumulation. DNA synthesis and repair are impaired and this could lead to cancer development.

Cyanocobalamin is the most common and widely produced of the chemical compounds that have vitamin activity as vitamin B12. Vitamin B12 is the “generic descriptor” name for any of such vitamers of vitamin B12. Because the body can convert cyanocobalamin to any one of the active vitamin B12 compounds, by definition this makes cyanocobalamin itself a form (or vitamer) of B₁₂, albeit a largely artificial one. Cyanocobalamin usually does not occur in living organisms, but animals can convert commercially produced cyanocobalamin into active (cofactor) forms of the vitamin, such as methylcobalamin. The amount of cyanide liberated in this process is so small that its toxicity is negligible.

The glycemic index or glycaemic index (GI) is a measure of how quickly blood glucose levels (i.e., blood sugar) rise after eating a particular type of food. Glucose (the defining standard) has a glycemic index of 100. The effects that different foods have on blood glucose levels vary considerably. The glycemic index estimates how much each gram of available carbohydrate (total carbohydrate minus fiber) in a food raises a person's blood glucose level following consumption of the food, relative to consumption of pure glucose.

A practical limitation of the glycemic index is that it does not take into account the amount of carbohydrate actually consumed. A related measure, the glycemic load, factors this in by multiplying the glycemic index of the food in question by the carbohydrate content of the actual serving. Watermelon has a high glycemic index, but a low glycemic load.

Another practical limitation of the glycemic index is that it does not measure insulin production due to raises in blood sugar. As a result, two foods could have the same glycemic index, but produce different amounts of insulin. Likewise, two foods could have the same glycemic load, but cause a totally different insulin response. Furthermore, both the glycemic index and glycemic load measurements are defined by the carbohydrate content of food. For something like steak, which has no carbohydrate content but can nonetheless trigger an insulin response due to high protein intake, GI and GL provide little information. When the two glycemic measurements cannot be used for comparison, the “insulin index” may be more useful.

Foods with carbohydrates that break down quickly during digestion and release glucose rapidly into the bloodstream tend to have a high GI; foods with carbohydrates that break down more slowly, releasing glucose more gradually into the bloodstream, tend to have a low GI. The concept was developed by Dr. David J. Jenkins and colleagues in 1980-1981 at the University of Toronto in their research to find out which foods were best for people with diabetes. A lower glycemic index suggests slower rates of digestion and absorption of the foods' carbohydrates and may also indicate greater extraction from the liver and periphery of the products of carbohydrate digestion. A lower glycemic response usually equates to a lower insulin demand but not always, and may improve long-term blood glucose control and blood lipids. The insulin index is also useful for providing a direct measure of the insulin response to a food.

The glycemic index of a food is defined as the incremental area under the two-hour blood glucose response curve (AUC) following a 12-hour fast and ingestion of a food with a certain quantity of available carbohydrate (usually 50 g). The AUC of the test food is divided by the AUC of the standard (either glucose or white bread, giving two different definitions) and multiplied by 100. The average GI value is calculated from data collected in 10 human subjects. Both the standard and test food must contain an equal amount of available carbohydrate. The result gives a relative ranking for each tested food.

The current validated methods use glucose as the reference food, giving it a glycemic index value of 100 by definition. This has the advantages of being universal and producing maximum GI values of approximately 100. White bread can also be used as a reference food, giving a different set of GI values (if white bread=100, then glucos≈; 140). For people whose staple carbohydrate source is white bread, this has the advantage of conveying directly whether replacement of the dietary staple with a different food would result in faster or slower blood glucose response. A disadvantage with this system is that the reference food is not well-defined.

| | |
|---|---|
| Low GI | 55 or less |
| Medium GI | 56-69 |
| High GI | 70 and above |

Other sources have characterized Low glycemic index as under 50, medium as between 50 and 70 and high between 70 and 100.

A low-GI food will release glucose more slowly and steadily, which leads to more suitable postprandial (after meal) blood glucose readings. A high-GI food causes a more rapid rise in blood glucose levels and is suitable for energy recovery after exercise or for a person experiencing hypoglycemia. The glycemic effect of foods depends on a number of factors, such as the type of starch (amylose versus amylopectin), physical entrapment of the starch molecules within the food, fat and protein content of the food and organic acids or their salts in the meal—adding vinegar, for example, will lower the GI. The presence of fat or soluble dietary fiber can slow the gastric emptying rate, thus lowering the GI. In general, coarse, grainy breads with higher amounts of fiber have a lower GI value than white breads. However, most breads made with 100% whole wheat or wholemeal flour have a GI not very different than endosperm only (white) bread. Many brown breads are treated with enzymes to soften the crust, which makes the starch more accessible (high GI).

While adding fat or protein will lower the glycemic response to a meal, the relative differences remain. That is, with or without additions, there is still a higher blood glucose curve after a high-GI bread than after a low-GI bread such as pumpernickel. Fruits and vegetables tend to have a low glycemic index. The glycemic index can be applied only to foods where the test relies on subjects consuming an amount of food containing 50 g of available carbohydrate. But many fruits and vegetables (not potatoes, sweet potatoes, corn) contain less than 50 g of available carbohydrate per typical serving. Carrots were originally and incorrectly reported as having a high GI. Alcoholic beverages have been reported to have low GI values; however, beer was initially reported to have a moderate GI due to the presence of maltose. This has been refuted by brewing industry professionals, who say that all maltose sugar is consumed in the brewing process and that packaged beer has little to no maltose present. Recent studies have shown that the consumption of an alcoholic drink prior to a meal reduces the GI of the meal by approximately 15%. Moderate alcohol consumption more than 12 hours prior to a test does not affect the GI.

Many modern commercial diets rely on the glycemic index. However, others have pointed out that foods generally considered to be unhealthy can have a low glycemic index, for instance, chocolate cake (GI 38), ice cream (37), or pure fructose (19), whereas foods like potatoes and rice have GIs around 100 but are commonly eaten in some countries with low rates of diabetes. The GI Symbol Program is an independent worldwide GI certification program that helps consumers identify low-GI foods and drinks. The symbol is only on foods or beverages that have had their GI values tested according to standard and meet the GI Foundation's certification criteria as a healthy choice within their food group, so they are also lower in kilojoules, fat and/or salt.

A low-GI diet over many years can significantly lower risk for developing type 2 diabetes, coronary heart disease, and age-related macular degeneration than others. High blood glucose levels or repeated glycemic “spikes” following a meal may promote these diseases by increasing systemic glycative stress, other oxidative stress to the vasculature, and also by the direct increase in insulin levels. The glycative stress sets up a vicious cycle of systemic protein glycation, compromised protein editing capacity involving the ubiquitin proteolytic pathway and autophagic pathways, leading to enhanced accumulation of glycated and other obsolete proteins.

The American Diabetes Association supports glycemic index but warns that the total amount of carbohydrate in the food is still the strongest and most important indicator, and that everyone should make their own custom method that works best for them.

The citric acid cycle—also known as the tricarboxylic acid cycle (TCA cycle), or the Krebs cycle, —is a series of chemical reactions used by all aerobic organisms to generate energy through the oxidation of acetate derived from carbohydrates, fats and proteins into carbon dioxide and chemical energy in the form of adenosine triphosphate (ATP). In addition, the cycle provides precursors of certain amino acids as well as the reducing agent NADH that is used in numerous other biochemical reactions. Its central importance to many biochemical pathways suggests that it was one of the earliest established components of cellular metabolism and may have originated abiogenically. The name of this metabolic pathway is derived from citric acid (a type of tricarboxylic acid) that is consumed and then regenerated by this sequence of reactions to complete the cycle. In addition, the cycle consumes acetate (in the form of acetyl-CoA) and water, reduces NAD⁺ to NADH, and produces carbon dioxide as a waste byproduct. The NADH generated by the TCA cycle is fed into the oxidative phosphorylation (electron transport) pathway. The net result of these two closely linked pathways is the oxidation of nutrients to produce usable chemical energy in the form of ATP.

In eukaryotic cells, the citric acid cycle occurs in the matrix of the mitochondrion. In prokaryotic cells, such as bacteria which lack mitochondria, the TCA reaction sequence is performed in the cytosol with the proton gradient for ATP production being across the cell's surface (plasma membrane) rather than the inner membrane of the mitochondrion.

Hangovers are a frequent, though unpleasant, experience among people who drink to intoxication. Despite the prevalence of hangovers, however, this condition is not well understood scientifically. Multiple possible contributors to the hangover state have been investigated, and researchers have produced evidence that alcohol can directly promote hangover symptoms through its effects on urine production, the gastrointestinal tract, blood sugar concentrations, sleep patterns, and biological rhythms. In addition, researchers postulate that effects related to alcohol's absence after a drinking bout (i.e., withdrawal), alcohol metabolism, and other factors (e.g., biologically active, nonalcohol compounds in beverages; the use of other drugs; certain personality traits; and a family history of alcoholism) also may contribute to the hangover condition. Few of the treatments commonly described for hangover have undergone scientific evaluation.

A hangover is characterized by the constellation of unpleasant physical and mental symptoms that occur after a bout of moderate to heavy alcohol drinking. Alcohol consumption in excess will lead to dehydration, metabolic toxicity and malnutrition which in turn lead to a hangover and its many usavory effects.

An embodiment of a beverage according to the present invention includes a low osmolality precovery/recovery beverage, which facilitates maximum absorption of fluid in the gut thereby preventing dehydration through excessive fluid loss in the kidneys. It can also prevent unfavorable metabolic processes leading to acetyladldehyde toxicity, the production of which is demonstrated below:

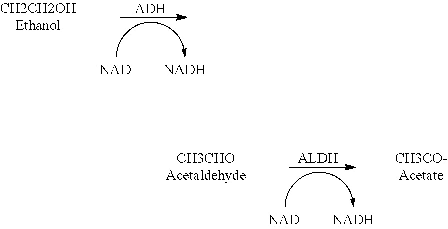

First, an enzyme (alcohol dehydrogenase) metabolizes alcohol to an intermediate product, acetaldehyde; then a second enzyme ALDH metabolizes acetaldehyde to acetate. These byproducts of alcohol metabolism have been implicated in the toxicities associated with alcohol consumption. The antioxidant effects of Thiamine (Vitamin B-1), Vitamin C, B-1, B-6, B-9, B-12, and Zinc and other carefully chosen ingredients of negate the symptoms of these unfavorable byproducts.

An embodiment of a beverage product according to the present invention, works towards the prevention and malabsorption & malnutrition via the replenishment of necessary vitamins, minerals & electrolytes otherwise lost as a result of alcohol consumption. Alcohol affects the secretion of the hormone ADH in the brain. This results in increase urine production and volume loss.

Possible contributing factors to hangover include the direct effects of alcohol such as dehydration & electrolyte imbalances. There are factors other than alcohol, which may also contribute to hangover symptoms including congeners or additives such as Methanol. Regular Alcohol consumption may lead to malabsorption of critical water soluble vitamins, electrolytes and minerals leading to malnutrition, anemia, nerve damage and osteoporosis

The mechanism of action of the formulas and beverages according to embodiments of the present invention is multi-faceted and directed to the primary contributing factors associated with the cause of hangover in general and not only the symptoms of a hangover, as described herein.

Although the present invention has been described in detail in connection with the above exemplary embodiments, it is to be understood that such detail is solely for that purpose and that variations can be made by those skilled in the art without departing from the spirt of the invention.

The invention claimed is:

1. A beverage providing relief from hangover symptoms by replenishment or preventative hydration and supplementation of nutrients lost as a result of alcohol consumption comprising a composition causing the beverage to be hypo-osmolar and comprise a low glycemic index.

2. The beverage of claim 1, comprising an osmolality range of 250-290 mmol/kg.

3. The beverage of claim 2, comprising an osmolality of less than or equal to 280 mmol/kg.

4. The beverage of claim 2, wherein the glycemic index is less than or equal to 55.

5. The beverage of claim 3, wherein the beverage comprises carbohydrates of 1 gram or less per 16 ounces.

6. The beverage of claim 1, further comprising 5 or less kilocalories per 16 fluid ounces.

7. The beverage of claim 1, further comprising β-Carotene for color enhancement.

8. The beverage of claim 2, wherein the composition comprises citric acid, β-Carotene, di-alpha tocopherol acetate, vitamin A palmitate, cholecalciferol, thiamin hydrochloride, pyridoxine hydrochloride, folic acid, and cyanocobalmin.

9. A water-soluble composition for a beverage for providing relief from hangover symptoms by replenishment or preventative hydration and supplementation of nutrients lost as a result of alcohol consumption comprising, when combined with water, an osmolality range of 250-290 mmol/kg.

10. A method of relieving hangover symptoms by replenishment or preventative hydration and supplementation of nutrients lost as a result of alcohol consumption comprising providing to a mammal a beverage including a composition causing the beverage to be hypo-osmolar and comprise a low glycemic index.
